(19) United States
(12) Patent Application Publication
(10) Pub. No.: US 2009/0202814 A1
(43) Pub. Date: Aug. 13, 2009

(54) Matrix and Layer System

(76) Inventors: Rene Jabado, Berlin (DE); Ursus Krüger, Berlin (DE); Daniel Körtvelyessy, Berlin (DE); Ralph Reiche, Berlin (DE); Michael Rindler, Schöneiche (DE); Jan Steinbach, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/887,290

(22) PCT Filed: Jan. 30, 2006
(86) PCT No.: PCT/EP2006/050506

§ 371 Date: Apr. 7, 2009

(30) Foreign Application Priority Data
Mar. 13, 2005 (EP) 05007093.7

(51) Int. Cl. B32B 15/02; B32B 5/16; F01D 5/28

(52) U.S. Cl. 428/325; 428/404; 428/406; 428/331; 416/241 R

(57) ABSTRACT

Prior art protective layers can exercise their protecting function because they are depleted in a specific element which forms a protective oxide, or which is used as sacrificial material. When said material has been consumed, the protecting function can no longer be provided. The invention is characterized in that it consists in using powder particles comprising a reserve of the consumed material, which is delivered in delayed manner. Therefor, the material is enclosed in an envelope.

### CROSS REFERENCE TO RELATED APPLICATIONS

This application is the US National Stage of International Application No. PCT/EP2006/050506, filed Jan. 30, 2006 and claims the benefit thereof. The International Application claims the benefits of European application No. 05007093.7 filed Mar. 31, 2005, both of the applications are incorporated by reference herein in their entirety.

### FIELD OF INVENTION

The invention relates to a matrix and to a layer system as claimed in the claims.

### BACKGROUND OF THE INVENTION

Components for high-temperature applications, for example turbine blades and combustion chamber walls of gas turbines, comprise protective layers against oxidation and corrosion. Such layers consist for example of an alloy of the MCrAlX type, a protective aluminum oxide layer being formed on this MCrAlX layer. The aluminum in this case diffuses from the MCrAlX alloy onto the surface of the MCrAlX layer, so that the alloy becomes depleted in respect of the element aluminum.

A preventively elevated proportion of aluminum in the MCrAlX alloy from the start, however, leads to inferior mechanical properties of an MCrAlX layer.

Compressor blades, which are provided with protective layers against corrosion and erosion, are furthermore known.

During production these comprise an inorganic binder with a metal, the metal being used as an electrolytic sacrificial element and therefore being electrically conductively connected to the substrate of the component. A suitable composition of such a protective layer is known from EP 0 142 418 B1.

Here again, the problem is that the metal becomes consumed over time, so that the protective function is no longer fulfilled.

Encapsulated abrasive ceramic powder particles, which consist of SiC (nonoxide ceramic), are known from U.S. Pat. No. 4,741,973. EP 0 933 448 B1 discloses oxide particles in a layer consisting of an aluminide.

### SUMMARY OF INVENTION

It is therefore an object of the invention to provide a matrix and a layer system, which have a longer protective effect.

The object is achieved by a matrix and a layer system as claimed in the claims.

### BRIEF DESCRIPTION OF THE DRAWINGS

Further advantageous measures, which may arbitrarily be combined with one another in an advantageous way, are listed in the respective dependent claims.

FIG. 1 shows a powder particle,

FIGS. 2-6 show exemplary embodiments according to the invention,

FIG. 7 shows a turbine blade,

FIG. 8 shows a combustion chamber and

FIG. 9 shows a gas turbine

### DETAILED DESCRIPTION OF INVENTION

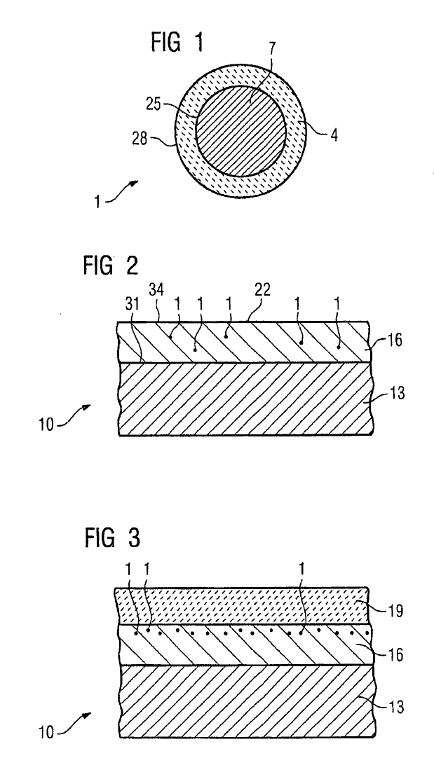

FIG. 1 shows a particle 1 in cross section for a matrix according to the invention.

The particle 1 consists of a core 7 and a shell 4.

The core 7 comprises a first element (chemical element!) or a first compound. A compound consists of a plurality of chemical elements.

The core 7 may consist of a metal, an organic compound (for example ceramic), a nonmetal oxide, a metal oxide i.e. an oxide, or a glass.

The core 7 does not consist of silicon carbide (SiC) or nonoxide ceramic (for example Si₃N₄).

The core 7 may likewise consist of sintered powder particles or a powder grain.

The core 7 is enclosed by a shell 4 which encapsulates the core 7 at least partially, in particular fully.

The shell 4 may also be porously designed.

The diameter of the core 7 may lie in the micro, submicro (<1 μm) or nano range (≦500 nm). The greatest transverse length of a polyhedron (core 7) may also be understood as a diameter.

The first element is in particular metallic and may for example be aluminum (Al).

The first element may likewise be chromium (Cr), an aluminum-chromium alloy or an aluminide. The core 7 may likewise be a mixture of two metals (for example chromium and aluminum) that can sometimes form an alloy, but which are not alloyed.

Alloys are also intended to be understood by the term metallic.

Further examples of the first element iron (Fe), titanium (Ti), platinum (Pt), yttrium (Y), zinc (Zn), tin (Sn) and/or copper (Cu).

The shell 4 comprises a second chemical element or a second compound, which is different to the first element of the first compound.

The second compound, i.e. the material of the shell 4, is in particular a ceramic (nonoxide or oxide ceramic) and is for example aluminum oxide and/or chromium oxide or another metal oxide such as iron oxide or titanium oxide or an oxide of the first metallic element or metallic compound.

An organic material may likewise be used for the shell 4, for example an Si—O—C compound.

The Si—O—C compound is in particular produced from a polysiloxane resin. Polysiloxane resins are polymer-ceramic precursors of the structural formula XSiO_{1.5}, where X may be =—CH₃, —CH, —CH₂, —C₆H_{S}, etc. The material is thermally crosslinked, inorganic constituents (Si—O—Si chains) and organic side chains predominantly of X being present beside one another. The precursors are subsequently ceramized via a heat treatment in an Ar, N₂, air or vacuum atmosphere at temperatures of between 600° C. and 1200° C. The polymer network is thereby decomposed and restructured via thermal intermediate stages from amorphous to crystalline phases, an Si—O—C network being created starting from polysiloxane precursors.

Precursors of the polysilane (Si—Si), polycarbosilane (Si—C), polysilazane (Si—N) or polybarosilazane (Si—B—C—N) type may likewise be used.

The second element may likewise be metallic and for example consist of titanium (Ti) or constitute an alloy.

Thus, for example, the following material combinations are possible for the particle 1 (organic=organic molecule):

core 7 of SiOC—shell 4 of metal
core 7 of SiOC—shell 4 of oxide (metal oxide or nonmetal oxide)
core 7 of SiOC—shell 4 of ceramic (organic or Si—O—C)
core 7 of SiOC—shell 4 of glass
core 7 of metal—shell 4 of metal
core 7 of metal—shell 4 of oxide (metal oxide or nonmetal oxide)
core 7 of metal—shell 4 of ceramic (organic or Si—O—C)
core 7 of metal—shell 4 of glass
core 7 of metal—shell 4 of polymer
core 7 of oxide—shell 4 of metal
core 7 of oxide—shell 4 of oxide (metal oxide or nonmetal oxide)
core 7 of oxide—shell 4 of ceramic (organic or Si—O—C)
core 7 of oxide—shell 4 of glass
core 7 of glass—shell 4 of metal
core 7 of glass—shell 4 of oxide (metal oxide or nonmetal oxide)
core 7 of glass—shell 4 of ceramic (organic or Si—O—C)
core 7 of glass—shell 4 of glass

The shell 4 may for example also have a gradient in the concentration of one of its constituents. For example, the core 7 of a powder particle 1 is formed from aluminum and the shell 4 partially from platinum, in which case the concentration of the material of the shell, preferably platinum, increases starting from the surface 25 of the core 7 as far as the outer surface 28 of the shell 4. The concentration of the core material, i.e. for example aluminum, in the shell thus decreases from the inside outward and preferably has the same or a higher concentration on the surface 28 of the shell 4 compared with the aluminum of the matrix.

Multilayered shells 4 may also be envisaged.

The layer thickness of the shell 4 is for example up to ⅕, in particular up to 1/10 of the diameter of the core 7, and is preferably 10 μm thick.

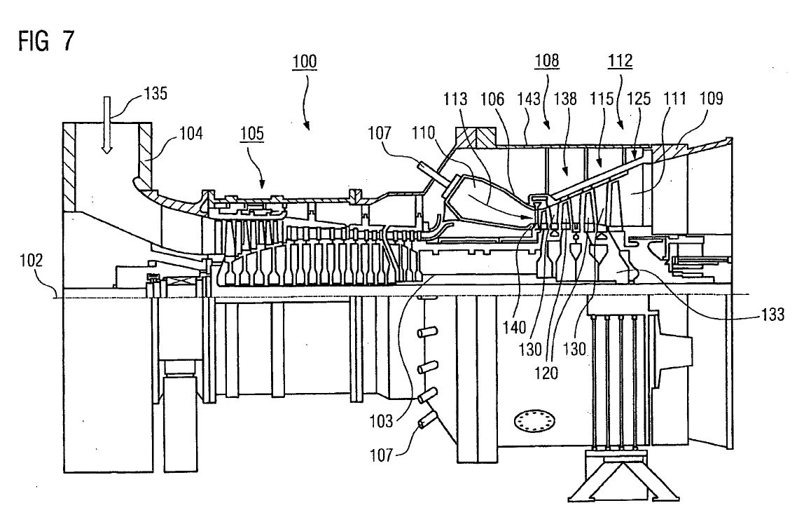

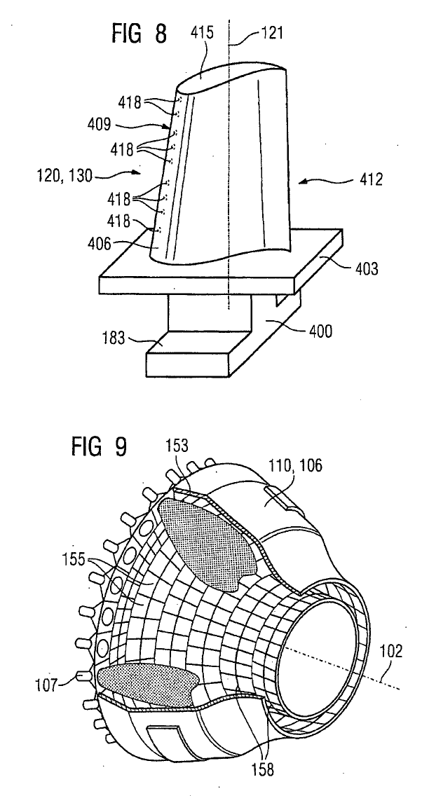

FIG. 2 shows a matrix according to the invention of a layer 16. The layer 16 is a part of a component 120, 130 (FIGS. 7, 9), a combustion chamber element 155 (FIG. 8) or a layer system 10, which consists of a substrate 13 on which the layer 16 is arranged.

The substrate 13 is for example a component for high temperatures, for example in steam or gas turbines 100 (FIG. 9), consisting of a nickel-, cobalt- or iron-based superalloy. Such layer systems 10 may be employed for turbine blades 120, 130, heat shield elements 155 or housing parts 138.

The layer 16 comprises a matrix of a matrix material, in which particles 1 are distributed homogeneously or locally differently (for example with a gradient).

The particles 1 are preferably distributed homogeneously in the matrix.

A plurality of layers 16, 19 may also be produced and used, the particles 1 being present in one or more sublayers or boundary layers. The particles 1 may be applied together by almost any coating method, i.e. by means of thermal plasma spraying (APS, VPS, LPPS), cold gas spraying, HVOF or an electrolytic coating method.

The matrix of the layer 16 may be a metal, a ceramic, a glass or a ceramic/organic compound (for example Si—O—C).

For example, the layer 16 is an alloy of the MCrAlX type and the particles 1 consist of a core 7 of aluminum. Aluminum-rich alloys are preferably used. The particles 1 may be distributed in the entire layer 16 or may be arranged locally concentrated near the outer surface 22 of the layer 16.

As already described above, the protective function of the MCrAlX alloy is obtained by the aluminum forming aluminum oxide, albeit while becoming depleted in the matrix material.

Aluminum of the core 7 has for example a diffusion coefficient in the material of the shell 4 which is lower by at least 5%, in particular at least 10% at the working temperatures than aluminum in the matrix of the layer 16, i.e. here in the MCrAlX alloy.

At high temperatures, the aluminum diffuses slowly through the shell 4 into the matrix of the layer 16 and thus replenishes the aluminum which has been consumed in the matrix material by the oxidation, so that the original composition of the MCrAlX alloy changes scarcely or not at all over the operating time, until there is no longer any aluminum in the powder particles 1.

The effect achieved by this is that the lifetime of the protective layer 16 is extended considerably.

The particles 1 may be present either only in the layer 16 (MCrAlX) or only in the substrate 13. It is likewise possible for the particles to be arranged both in a layer 16 and in the substrate 13.

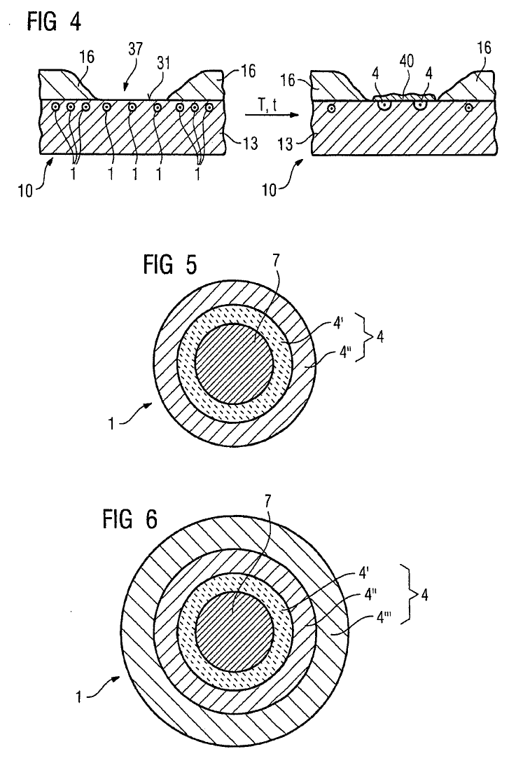

Irrespective of whether the particles 1 are also arranged in a layer 16 which is present on the substrate 13, the following protective function is obtained when the particles 1 are present in the substrate 13: During use of the layer system 10, it may happen that the layer 16 (MCrAlX or MCrAlX+ceramic) is shed in a region 37, so that a part of the surface 31 of the substrate 13 is unprotected (FIG. 4). However, the particles 1 are arranged in the superficial region. Owing to further use of the layer system 10 at high temperatures T for a prolonged time t, the surface 31 of the substrate 13 corrodes in the region 37 so that the shells 4 of the particles 1 are abrasively or thermally disintegrated and the core 7 of the particle 1 is released. By reaction of the material of the core 7, a protective function is obtained in the region 37 of the substrate 13. In the case of superalloys which are used for gas turbine blades, the core 7 consists of aluminum or an alloy containing aluminum, so that a protective layer 40 of aluminum oxide, created by oxidation of the aluminum 7 of the core of the particles 1, is formed in the region 37.

It may likewise be possible that the elevated temperatures which the particles 1 experience without a layer 16 in the region 37 increase the diffusion through the shell 4, so that the aluminum can reach the surface in the region 37 even without breaking down the shell 4, and can be oxidized there in order that a protective oxide layer 40 can be formed.

These particles 1 may likewise be used to reinforce the superalloy, as is known from so-called ODS alloys. The size of the particles 1 preferably corresponds to the optimal size of the γ′ phase of a superalloy.

The particles 1 are preferably already present in the melt and are co-cast. With respect to the arrangement and activity of ceramic particles in a superalloy, reference is made to the prior art relating to ODS alloys. The particles 1 then have the function: improving the mechanical properties and achieving an emergency backup property.

The material of the shell 4 may likewise be selected so that the shell 4 is disintegrated by diffusion in the crystal structure of the matrix material of the layer 16 and optionally forms precipitates in the matrix material, and thus does not allow diffusion of the material of the core 7 directly into the matrix until after a certain time, since until this time the protective function for example of the MCrAlX layer is still provided.

The second element or an element of the second compound of the shell 4 in this case has for example a higher diffusion coefficient in the matrix material than in the first element or in the first compound.

The shell 4 may also be disintegrated abrasively and/or thermally and/or chemically, so that the core 7 is thereby released.

A metal, for example aluminum, in the layer 16 of a compressor blade may also be enclosed by a shell 4 for example of aluminum oxide as described above, in which case the aluminum oxide contributes to increasing the erosion resistance when it is arranged at least in the vicinity of the surface.

The layer 16 may likewise constitute a protective layer against corrosion and/or erosion of a compressor blade, in which case the effect of the particles 1 in a layer 16 with the chemical composition according to Patent EP 0 142 418 B1 is that enough sacrificial material is made available for the desired protective function to be obtained over a significantly longer period of time.

The first element, in particular aluminum, is in this case enclosed by a shell 4 for example of a binder or polymer.

There may in this case be a local concentration gradient of the particles 1 inside the layer 16 or also the substrate 13. For example, the concentration of the particles 1 increases starting from the surface 31 of the substrate 13 as far as a surface 34 of the layer 16.

During the compression of air in the compressor, water may be formed which under certain circumstances, in conjunction with other elements contained in the air, forms an electrolyte that can lead to corrosion and erosion on the compressor blades. In order to prevent the corrosion and/or erosion, compressor blades are therefore generally provided with coatings. In particular coatings 16, which comprise a for example phosphate-bound base matrix with metal particles such as aluminum particles dispersely distributed therein, may be envisaged in this case. The protective effect of such a coating consists in the metal particles embedded in the base coating, together with the (nobler) metal of the compressor blade and the electrolyte, forming an electrolytic cell in which the metal particles form so-called sacrificial anodes. The oxidation or the corrosion then takes place in the sacrificial anodes, i.e. in the metal particles and not in the metal of the compressor blade.

The phosphate-bound base matrix of the coating has glass-ceramic properties, is thermally stable, likewise corrosion-resistant and protects against mechanical effects such as abrasion and erosion.

Besides the metal particles, the coating may contain further particles As fillers. Colorant particles may be mentioned by way of example at this point.

Besides phosphate-bound coatings, other types of coatings 16 may be envisaged. EP 0 142 418 B1, EP 0 905 279 A1 and EP 0 995 816 A1 describe coatings based on chromate/phosphate. EP 1 096 040 A2 describes a coating 16 based on phosphate/borate and EP 0 933 446 B1 describes a coating based on phosphate/permanganate.

FIG. 3 shows another exemplary application of the layer 16 according to the invention.

The layer system 10 consists of a substrate 13, a layer 16 according to the invention with a further layer 19 on the matrix of the layer 16.

This is for example a layer system 10 for high-temperature applications, the substrate 13 again constituting a superalloy as described above and the layer 16 comprising a matrix of the MCrAlX type. The layer 19 then constitutes a ceramic thermal insulation layer, the protective aluminum oxide layer (TGO) being formed between the layer 16 and the layer 19 (not shown). The particles 1 are, for example, concentrated near the interface between the layers 16 and 19.

A component may also be envisaged which is made of a material that comprises the particles 1, i.e. they are present not in a coating but in a solid material.

FIG. 5 shows another particle 1 according to the invention.

The particle 1 again consists of the core 7, an inner shell 4′ around the core 7 and a further shell 4″ around the inner shell 4′.

The particle 1 may also comprise multilayered shells 4. The core 7 preferably comprises a metal, the shell 4′ a ceramic and the outer shell 4″ a metal.

It is likewise advantageous for the core 7 to consist of a metal, for the inner shell 4′ to consist of a metal which in particular is different to the material of the core 7, and for an outer shell 4″ to consist of a ceramic.

The core 7 may likewise be a cavity, the inner shell 4′ of metal and the outer shell 4″ of ceramic.

Another particle 1 for a matrix 1 according to the invention is depicted in FIG. 6.

The particles 1 comprise a three-layered shell.

Exemplary embodiments for the sequence of the material in the shell materials 4′, 4″, 4′″ are presented in the following table.

| | material | material | material | material | material | material | material |
|---|---|---|---|---|---|---|---|
| 4′ | metal | metal | metal | metal | ceramic | ceramic | ceramic |
| 4″ | metal | ceramic | ceramic | metal | metal | metal | ceramic |
| 4″′ | ceramic | metal | ceramic | metal | metal | ceramic | metal |

The metal of the shell 4′ may be different to the metal of the shell 4″ or 4′″.

Here again, the core 7 may be a cavity.

The metals of the shells 4′, 4″ (FIG. 5) and 4′″ (FIG. 6) may also be different to the metal of the core 7.

The layer thicknesses of the shells 4′, 4″, 4′″ may be individually adapted, and above all different.

FIG. 7 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening region 400, a blade platform 403 adjacent thereto and a blade surface 406 and a blade tip 415.

As a guide vane 130, the vane 130 may have a further platform (not shown) at its vane tip 415.

A blade root 183 which is used to fasten the rotor blades 120, 130 on a shaft or a disk (not shown) is formed in the fastening region 400.

The blade root 183 is configured, for example, as a hammerhead. Other configurations as a fir tree or dovetail root are possible.

The blade 120, 130 comprises a leading edge 409 and a trailing edge 412 for a medium which flows past the blade surface 406.

In conventional blades 120, 130, for example, solid metallic materials, in particular superalloys, are used in all regions 400, 403, 406 of the blade 120, 130.

Such superalloys are known, for example, from EP 1 204 776 B1, EP 1 306 454, EP 1 319 729 A1, WO 99/67435 or WO 00/44949; these documents are part of the disclosure in respect of the chemical composition of the alloy.

The blades 120, 130 may in this case be manufactured by a casting method, also by means of directional solidification, by a forging method, by a machining method or combinations thereof.

Workpieces with a monocrystalline structure or structures are used as components for machines which are exposed to heavy mechanical, thermal and/or chemical loads during operation.

Such monocrystalline workpieces are manufactured, for example, by directional solidification from the melt. These are casting methods in which the liquid metal alloy is solidified to form a monocrystalline structure, i.e. to form the monocrystalline workpieces, or directionally.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a monocrystalline structure, i.e. the entire workpiece consists of a single crystal. It is necessary to avoid the transition to globulitic (polycrystalline) solidification in this method, since nondirectional growth will necessarily form transverse and longitudinal grain boundaries which negate the good properties of the directionally solidified or monocrystalline component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures. Such methods are known from U.S. Pat. No. 6,024,792 and EP 0 892 090 A1; these documents are part of the disclosure in respect of the solidification method.

The blades 120, 130 may likewise comprise coatings against corrosion or oxidation, for example (MCrAlX; M is at least one element from the group iron (Fe), cobalt (Co), nickel (Ni), X is an active element and stands for yttrium (Y) and/or and/or silicon at least one rare-earth element, for example hafnium (Hf)). Such alloys are known, for example, from EP 0 486 489 B1, EP 0 786 017 B1, EP 0 412 397 B1 or EP 1 306 454 A1, which are intended to be part of this disclosure in respect of the chemical composition of the alloy.

The density is preferably 95% of the theoretical density.

On the MCrAlX layer (as an interlayer or as the outermost layer), a protective aluminum oxide layer is formed (TGO=thermally grown oxide layer). The MCrAlX layer or the substrate comprises a matrix according to the invention.

On the MCrAlX, there may also be a thermal insulation layer which is preferably at the outermost layer and consists for example of ZrO₂, Y₂O₃—ZrO₂, i.e. it is non-stabilized or partially or fully stabilized by yttrium oxide and/or calcium oxide and/or magnesium oxide.

The thermal insulation layer covers the entire MCrAlX layer.

Rod-shaped grains are generated in the thermal insulation layer by suitable coating methods, for example electron beam deposition (EB-PVD).

Other coating methods are conceivable, for example atmospheric plasma spraying (APS), LPPS, VPS or CVD. The thermal insulation layer may comprise grains which are porous or affected by micro- or macrocracks for better thermal shock resistance. The thermal insulation layer is thus preferably more porous than the MCrAlX layer.

Refurbishment means that components 120, 130 may need to have protective layers removed from them after their use (for example by sandblasting). Corrosion and/or oxidation layers or products are then removed. Optionally, cracks in the component 120, 130 will also be repaired. The component 120, 130 is then recoated and the component 120, 130 is used again.

The blade 120, 130 may be designed to be a hollow or solid. If the blade 120, 130 is intended to be cooled, it will be hollow and optionally also comprise film cooling holes 418 (represented by dashes).

FIG. 8 shows a combustion chamber 110 of a gas turbine 100. The combustion chamber 110 is designed for example as a so-called ring combustion chamber, in which a multiplicity of burners 107 arranged in the circumferential direction around a rotation axis 102, which produce flames 156, open into a common combustion chamber space 154. To this end, the combustion chamber 110 in its entirety is designed as an annular structure which is positioned around the rotation axis 102.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side fining the working medium M.

Each heat shield element 155 made of an alloy is equipped with a particularly heat-resistant protective layer on the working medium side (MCrAlX layer and/or ceramic coating), or is made of refractory material (solid ceramic blocks).

These protective layers may be similar to the turbine blades, i.e. for example MCrAlX: M is at least one element from the group iron (Fe), cobalt (Co), nickel (Ni), X is an active element and stands for yttrium (Y) and/or at least one rare-earth element, for example hafnium (Hf). Such alloys are known, for example, from EP 0 486 489 B1, EP 0 786 017 B1, EP 0 412 397 B1 or EP 1 306 454 A1, which are intended to be part of this disclosure in respect of the chemical composition of the alloy.

The MCrAlX layer or the substrate of the heat shield element 155 comprises of the matrix according to the invention.

On the MCrAlX, there may also be an e.g. ceramic thermal insulation layer which consists for example of ZrO₂, Y₂O₃—ZrO₂, i.e. it is non-stabilized or partially or fully stabilized by yttrium oxide and/or calcium oxide and/or magnesium oxide.

Rod-shaped grains are generated in the thermal insulation layer by suitable coating methods, for example electron beam deposition (EB-PVD).

Other coating methods are conceivable, for example atmospheric plasma spraying (APS), LPPS, VPS or CVD. The thermal insulation layer may comprise grains which are porous or affected by micro- or macrocracks for better thermal shock resistance.

Refurbishment means that heat shield elements 155 may need to have protective layers removed from them after their use (for example by sandblasting). Corrosion and/or oxidation layers or products are then removed. Optionally, cracks in the heat shield element 155 will also be repaired. The heat shield elements 155 are then recoated and the heat shield elements 155 are used again.

Owing to the high temperatures inside the combustion chamber 110, a cooling system is also provided for the heat shield elements 155 or their holding elements. The heat shield elements 155 are then for example hollow and optionally also comprise cooling holes (not shown) opening into the combustion chamber space 154.

FIG. 9 shows by way of example a gas turbine 100 in a longitudinal partial section.

The gas turbine 100 internally comprises a rotor 103, or turbine rotor, mounted so that it can rotate about a rotation axis 102 and having a shaft 101.

Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109.

The ring combustion chamber 106 communicates with an e.g. annular hot gas channel 111. There, for example, four successively connected turbine stages 112 form the turbine 108.

Each turbine stage 112 is formed for example by two blade rings. As seen in the flow direction of a working medium 113, a row 125 formed by rotor blades 120 follows in the hot gas channel 111 of a guide vane row 115.

The guide vanes 130 are fastened on the stator 143 while the rotor blades 120 of a row 125 are fitted on the rotor 103, for example by means of a turbine disk 133.

Coupled to the rotor 103, there is a generator or a work engine (not shown).

During operation of the gas turbine 100, air 135 is taken in by the compressor 105 through the intake manifold 104 and compressed. The compressed air provided at the turbine-side end of the compressor 105 is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

During operation of the gas turbine 100, the components exposed to the hot working medium 113 experience thermal loads. Apart from the heat shield elements lining the ring combustion chamber 110, the guide vanes 130 and rotor blades 120 of the first turbine stage 112, as seen in the flow direction of the working medium 113, are thermally loaded most greatly.

In order to withstand the temperatures prevailing there, they may be cooled by means of a coolant.

The substrates may likewise comprise a directional structure, i.e. they are monocrystalline (SX structure) or comprise only longitudinally directed grains (DS).

Iron-, nickel- or cobalt-based superalloys, for example, are used as material for the components, in particular for the turbine blades and vanes 120, 130 and components of the combustion chamber 110.

Such superalloys are known, for example, from EP 1 204 776 B1, EP 1 306 454, EP 1 319 729 A1, WO 99/67435 or WO 00/44949; these documents are part of the disclosure in respect of the chemical composition of the alloy.

The blades and vanes 120, 130 may likewise comprise coatings against corrosion (MCrAlX; M is at least one element in the group iron (Fe), cobalt (Co), nickel (Ni), X stands for yttrium (Y) and/or silicon, scandium (Sc) and/or at least one rare-earth element or hafnium). Such alloys are known, for example, from EP 0 486 489 B1, EP 0 786 017 B1, EP 0 412 397 B1 or EP 1 306 454 A1, which are intended to be part of this disclosure in respect of the chemical composition of the alloy.

On the MCrAlX, there may also be a thermal insulation layer which consists for example of ZrO₂, Y₂O₃—ZrO₂, i.e. it is non-stabilized or partially or fully stabilized by yttrium oxide and/or calcium oxide and/or magnesium oxide.

Rod-shaped grains are generated in the thermal insulation layer by suitable coating methods, for example electron beam deposition (EB-PVD).

The guide vanes 130 comprise a guide vane root (not shown here) facing the inner housing 138 of the turbine 108, and a guide vane head lying opposite the guide vane root. The guide vane head faces the rotor 103 and is fixed on a fastening ring 140 of the stator 143.

1.-42. (canceled)

43. A matrix for a component or a layer having a matrix containing particles, comprising:
a core having a first element or compound that are selected from the group consisting of:
a metal, a metal oxide, a nonmetal oxide, a glass, a Si—O—C compound and combinations thereof; and
a shell having a second element or a second compound around the core, wherein the shell material is at least partially a metal oxide.

44. The matrix as claimed in claim 43, wherein the first element or compound has a diffusion coefficient in the second element or compound which is lower by at least 10% than the first element or compound has in the matrix material.

45. The matrix as claimed in claim 44, wherein the core is not a non-oxide ceramic.

46. The matrix as claimed in claim 44, wherein the first element or compound selected from the group consisting of: chromium, aluminum, a combination of chromium and aluminum, an aluminum-chromium alloy, a nickel-aluminum alloy and an aluminide.

47. The matrix as claimed in claim 44, wherein the second element or compound is soluble in the crystal structure of the matrix or is suitable for the formation of precipitates in the matrix material, so that the shell can at least partially dissolve in the matrix.

48. The matrix as claimed in claim 47, wherein the second compound is Al₂O₃ and/or Cr₂O₃.

49. The matrix as claimed in claim 47, wherein the shell is porous.

50. The matrix as claimed in claim 47, wherein the shell has a concentration gradient of a material present in the core that decreases radially outward from the core to the shell.

51. The matrix as claimed in claim 46, wherein the core is granularly designed and the matrix material is ceramic, glass-ceramic or metallic.

52. The matrix as claimed in claim 51, wherein the shell consists of a plurality of layers

53. The matrix as claimed in claim 52, wherein
the core is metallic, a first shell around the core is metallic, and in that an outer shell on an inner shell is a ceramic layer, or
the core is metallic, a shell around the core is a ceramic and an outer shell is metallic, or
the core is metallic, the first shell is ceramic, a second shell surrounding the first shell is metallic and an outer shell is ceramic, or
the core is metallic, the first shell is metallic, the second shell is metallic and the outer shell is ceramic.

54. The matrix as claimed in claim 52, wherein a layer thicknesses of the plurality of layers are each different.

55. The matrix as claimed in claim 47, wherein the matrix material is an alloy of the MCrAlX type.

56. The matrix as claimed in claim 51, wherein the core diameter is ≦500 nm.

57. A layer system, comprising:
a cobalt-, nickel- or iron-based superalloy substrate; and
a layer arranged on the substrate having a matrix material comprising:
a core having a first element or compound that is selected from the group consisting of: a metal, a metal oxide, a nonmetal oxide, a glass, a Si—O—C compound and combinations thereof; and
a shell having a second element or a second compound around the core, wherein the shell material is at least partially a metal oxide and there is a gradient in the concentration of the particles inside the layer.

58. The layer system as claimed in claim 57, wherein a further layer is arranged on the layer.

59. The layer system as claimed in claim 58, wherein at least one of the layers has a matrix of MCrAlX applied, on which there is a ceramic thermal insulation layer consisting of zirconium oxide.

60. The layer system as claimed in claim 59, wherein the layer system is applied to a turbine blade, a heat shield element or a housing part of a gas turbine or steam turbine.

61. The layer system as claimed in claim 60, wherein the layer system is applied to a compressor blade of a gas turbine.
